(19) United States
(12) Patent Application Publication
(10) Pub. No.: US 2025/0033452 A1
(43) Pub. Date: Jan. 30, 2025

(54) HYBRID ELECTRIC VEHICLE BATTERY MOUNTING

(71) Applicant: JAGUAR LAND ROVER LIMITED, Whitley (GB)

(72) Inventor: James MORRAD, Coventry (GB)

(21) Appl. No.: 18/360,511

(22) Filed: Jul. 27, 2023

(51) Int. Cl. B60K 1/04; B60K 17/24; H01M 50/249; H01M 50/262

(52) U.S. Cl. CPC B60K 1/04; B60K 17/24; H01M 50/249; H01M 50/262; B60K 2001/0438; B62D 25/20; H01M 2220/20

(57) ABSTRACT

The disclosure relates to a vehicle subassembly for mounting a battery to a vehicle underbody and accommodates one or more vehicle powertrain components. In particular, the vehicle subassembly accommodates a propshaft. The disclosure also relates to a propshaft mounting assembly, and to a vehicle.

### TECHNICAL FIELD

The present disclosure relates to a mount for a battery that accommodates one or more vehicle powertrain components. More specifically, the present disclosure relates to a mount for a battery of a hybrid electric vehicle, and in particular a plug-in hybrid electric vehicle. Aspects of the invention relate to a vehicle subassembly, to a propshaft mounting assembly, and to a vehicle.

### BACKGROUND

Plug-in hybrid electric vehicles (PHEV) combine a traditional internal combustion engine powertrain system with an on-board battery that can be charged through connection with mains electricity.

PHEVs provide a number of challenges when attempting to package traditional powertrain components alongside a battery, due to the size of the battery required.

This is primarily as a result of space constraints in the underside of a vehicle and is a particular challenge in the case of front engine rear-wheel drive and all-wheel drive vehicles, as the propshaft must extend along part of the length of the vehicle between the front and rear axles.

### SUMMARY OF THE INVENTION

It is an aim of the present invention to address one or more of the disadvantages associated with the prior art.

A broad aspect relates to a vehicle subassembly comprising: a vehicle underbody; a battery; a propshaft extending along a longitudinal axis and positioned between the vehicle underbody and the battery; and a battery mount for forming a structural connection between the vehicle underbody and the battery, the battery mount comprising: a first end fixed to the vehicle underbody; a second end fixed to the battery; and a propshaft bearing housing, the propshaft bearing housing configured to rotatably support the propshaft and located between the first end of the battery mount and the second end of the battery mount, wherein the propshaft extends through and is supported by the propshaft bearing housing.

A broad aspect relates to a vehicle subassembly comprising: a vehicle underbody, a battery frame for securing a battery to a vehicle, a propshaft extending between the vehicle underbody and the battery frame, and a battery mounting assembly comprising: a first end secured to the vehicle underbody; and a second end secured to the battery frame; and a propshaft bearing housing located between the first end and the second end, and wherein the propshaft extends through the propshaft bearing housing.

A broad aspect relates to a vehicle subassembly comprising: a vehicle underbody, a battery, a propshaft extending between the vehicle underbody and the battery, and a battery mount comprising: a first end secured to the vehicle underbody; and a second end secured to the battery; and a propshaft bearing housing located between the first end and the second end, and wherein the propshaft extends through the propshaft bearing housing.

A broad aspect relates to a vehicle subassembly comprising: a vehicle underbody, a battery frame for securing a battery to a vehicle, a propshaft extending along a longitudinal axis between the vehicle underbody and the battery frame, and a battery mounting assembly comprising: a first end secured to the vehicle underbody; a second end secured to the battery frame; and a propshaft bearing housing between the first end and the second end, wherein the propshaft extends through the propshaft bearing housing.

A broad aspect relates to a vehicle subassembly comprising: a vehicle underbody; a battery frame for securing a battery to a vehicle; a propshaft extending between the vehicle underbody and the battery frame; and a battery mounting assembly comprising: a first end secured to the vehicle underbody and a second end secured to the battery frame and a propshaft bearing located between the first end and the second end.

A broad aspect relates to a vehicle subassembly comprising: a vehicle underbody; a battery frame for securing a battery to the vehicle underbody; a propshaft extending between the vehicle underbody and the battery frame; and a battery mounting assembly comprising: a first end secured to the vehicle underbody and a second end secured to the battery frame and a propshaft bearing housing located between the first end and the second end, and wherein the propshaft extends through the propshaft bearing housing.

A broad aspect relates to a vehicle subassembly comprising: a vehicle underbody; a battery frame for securing a battery to a vehicle; a propshaft extending between the vehicle underbody and the battery frame; and a battery mounting assembly comprising a first end secured to the vehicle underbody and a second end secured to the battery frame.

A broad aspect relates to a vehicle subassembly comprising: a vehicle underbody; a battery frame for securing a battery to a vehicle; and a battery mounting assembly comprising a first end secured to the vehicle underbody and a second end secured to the battery frame.

A broad aspect relates to a vehicle subassembly comprising: a vehicle underbody; a battery; and a battery mount comprising a first end secured to the vehicle underbody and a second end secured to the battery.

A broad aspect relates to a vehicle subassembly comprising: a vehicle floor; a battery module; a propshaft located between the vehicle floor and the battery module; and a battery mounting assembly comprising: a first portion connected to the vehicle floor; a second portion connected to the battery module; a propshaft bearing housing, wherein the propshaft extends through the propshaft bearing housing.

A broad aspect relates to a vehicle comprising: a vehicle floor; a battery module; a propshaft located between the vehicle floor and the battery module; and a battery mounting assembly comprising: a first portion connected to the vehicle floor; a second portion connected to the battery module; a propshaft bearing housing, wherein the propshaft extends through the propshaft bearing housing.

A broad aspect relates to a vehicle subassembly comprising: a vehicle floor; a battery; a propshaft located between the vehicle floor and the battery; and a battery mount comprising: a first portion connected to the vehicle floor; a second portion connected to the battery; a propshaft bearing housing, wherein the propshaft extends through and is rotatably supported by the propshaft bearing housing.

A broad aspect relates to a vehicle subassembly comprising: a vehicle floor; a battery module; a propshaft located between the vehicle floor and the battery module; and a battery mounting assembly comprising: a first portion connected to the vehicle floor; a second portion connected to the battery module; a propshaft bearing located between the first portion and the second portion.

A broad aspect relates to a vehicle subassembly comprising: a vehicle floor; a battery module; a propshaft located between the vehicle floor and the battery module; and a battery mounting assembly comprising a first portion connected to the vehicle floor and a second portion connected to the battery module.

A broad aspect relates to a vehicle subassembly comprising: a vehicle floor; a battery module; and a battery mounting assembly comprising a first portion connected to the vehicle floor and a second portion connected to the battery module.

A broad aspect relates to a vehicle subassembly comprising: a vehicle floor; a battery; and a battery mount comprising a first portion connected to the vehicle floor and a second portion connected to the battery.

A broad aspect relates to a plug-in hybrid electric vehicle subassembly comprising: a vehicle floor; a battery module; and a battery mounting assembly comprising a first portion connected to the vehicle floor and a second portion connected to the battery module.

A broad aspect relates to a propshaft mounting assembly comprising: a propshaft bearing housing: a vehicle underbody mounting assembly on a first side of the propshaft bearing housing, the vehicle underbody mounting assembly comprising one or more fasteners for connection to a vehicle underbody; and a battery mounting assembly on a second side of the propshaft bearing housing, wherein the battery mounting assembly comprises one or more fasteners for connection to a battery frame.

A broad aspect relates to a propshaft mounting assembly comprising: a propshaft bearing housing: a vehicle underbody mounting assembly on a first side of the propshaft bearing housing, the vehicle underbody mounting assembly comprising one or more fasteners for connection to a vehicle underbody; and a battery mount on a second side of the propshaft bearing housing, wherein the battery mount comprises one or more fasteners for connection to a battery.

A broad aspect relates to a propshaft mounting assembly comprising: a propshaft bearing: a vehicle underbody mounting assembly on a first side of the propshaft bearing, the vehicle underbody mounting assembly comprising one or more fasteners for connection to a vehicle underbody; and a battery mounting assembly on a second side of the propshaft bearing, wherein the battery mounting assembly comprises one or more fasteners for connection to a battery frame.

A broad aspect relates to a battery mounting assembly comprising: a propshaft bearing housing: a vehicle underbody mounting assembly on a first side of the propshaft bearing housing, the vehicle underbody mounting assembly comprising one or more fasteners for connection to a vehicle underbody; and a battery mount on a second side of the propshaft bearing housing, wherein the battery mount comprises one or more fasteners for connection to a battery frame.

A broad aspect relates to a propshaft mounting assembly comprising: a propshaft bearing housing having a first end for attachment to a vehicle underbody and a second end for attachment to a battery frame.

A broad aspect relates to a propshaft mounting assembly comprising: a propshaft bearing housing having a first end for attachment to a vehicle underbody and a second end for attachment to a battery.

A broad aspect relates to a propshaft mounting assembly comprising: a propshaft; and a propshaft bearing housing having a first end for attachment to a vehicle underbody and a second end for attachment to a battery frame, wherein the propshaft extends through the propshaft bearing housing.

A broad aspect relates to a propshaft mounting assembly comprising: a propshaft; a battery frame for securing a battery to a vehicle; and a propshaft bearing housing having a first end for attachment to a vehicle underbody and a second end for attachment to the battery frame, wherein the propshaft extends through the propshaft bearing housing.

According to an aspect of the invention, there is provided a vehicle comprising the vehicle subassembly described above, the battery mounting assembly described above or the propshaft mounting assembly described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a perspective view of a vehicle subassembly according to an embodiment of the invention;

FIG. 2 shows a front end view of the vehicle subassembly of FIG. 1;

FIG. 3 shows a side view of the vehicle subassembly of FIG. 1;

FIG. 4 shows a front end view of a battery mount forming part of the vehicle subassembly of FIG. 1;

FIG. 5 shows a side view of the battery mount of FIG. 4;

FIG. 6 shows a rear perspective view of the battery mount of FIG. 4;

FIG. 7 shows a front view of a mounting bracket of the battery mount of FIG. 4; and

FIG. 8 shows a vehicle in accordance with an embodiment of the invention.

### DETAILED DESCRIPTION

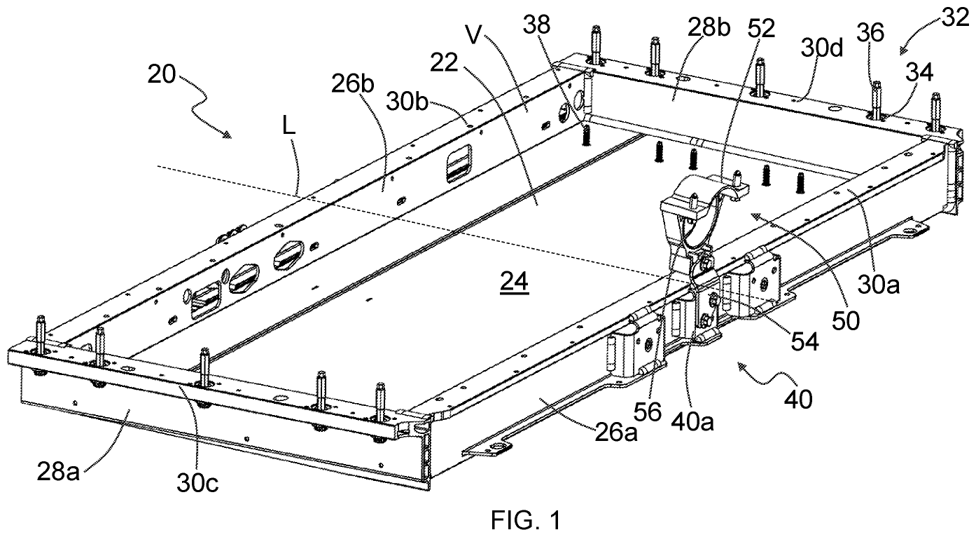

A vehicle subassembly 10 in accordance with an embodiment of the invention is described herein with reference to accompanying FIGS. 1 to 3.

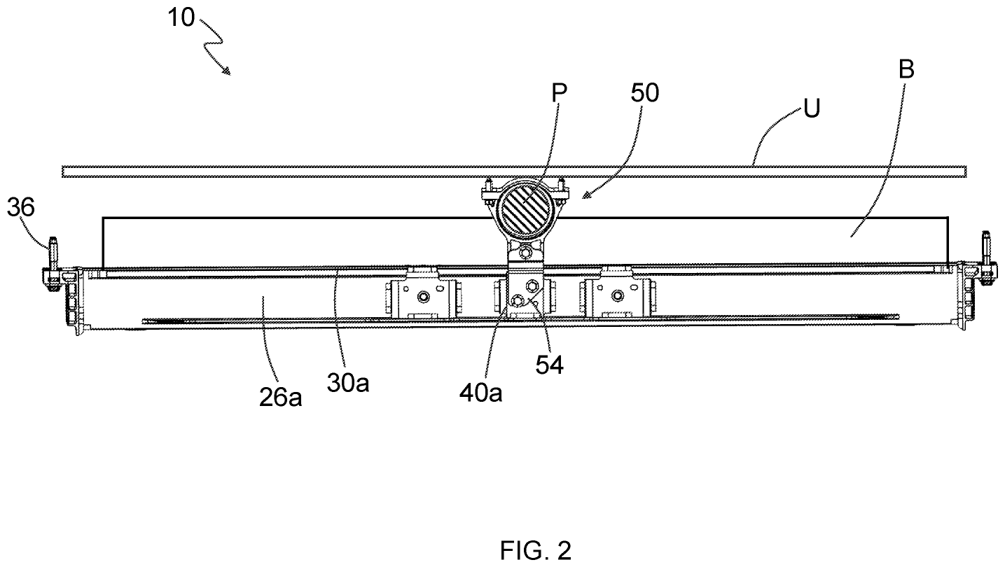

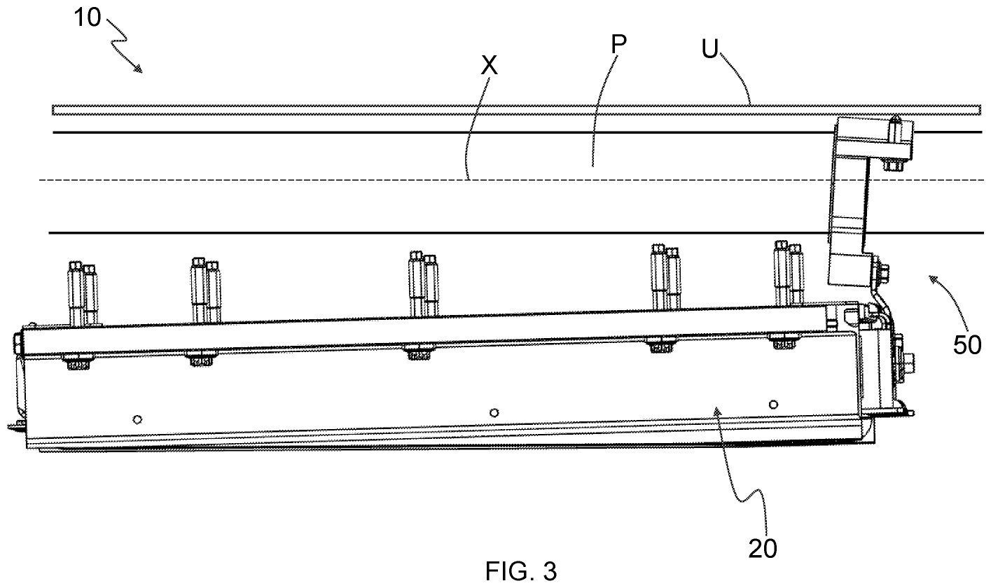

The vehicle subassembly 10 includes a battery frame 20 for securing a battery B (FIG. 2) to a vehicle underbody U (FIGS. 2 and 3). A propshaft P (FIG. 3) has a longitudinal axis X and is positioned between the battery B and the vehicle underbody U in order to transmit power from an internal combustion engine to the rear wheels of a vehicle, in use. The vehicle subassembly 10 further includes a battery mount 50 fixed to the vehicle underbody U at a first end 52 and fixed to the battery frame 20 at a second end 54. The battery mount 50 forms a structural connection between the vehicle underbody U and the battery B in this embodiment.

A propshaft bearing housing 56, through which the propshaft P extends, is located between the first and second ends 52, 54. The propshaft bearing housing 56 also rotatably supports the propshaft P. To put it another way, the propshaft bearing housing 56 is configured such that the propshaft P is supported by the propshaft bearing housing 56 but able to rotate within it. The vehicle subassembly 10 has a longitudinal axis L that is parallel with the longitudinal axis X of the propshaft P. It will be appreciated that the longitudinal axis L need not be parallel with the longitudinal axis X of the propshaft P. Furthermore, the battery mount 50 may be replaced with a battery mounting assembly. It will also be appreciated that the battery mount 50 may be secured to the battery B at the second end 54.

As will be described in greater detail hereinafter, the vehicle subassembly 10 provides a mounting point for mounting a battery to a vehicle underbody, whilst also incorporating a support for a propshaft P. This has particular application in front engine plug-in hybrid electric vehicles, with rear-wheel drive or all-wheel drive capability where a battery and propshaft must be packaged within a restricted or confined space and the propshaft may pass over or through the battery. It will be appreciated that the vehicle subassembly 10 would also find application in other vehicle types.

The vehicle subassembly 10 may be replaced with a vehicle assembly or a vehicle. The vehicle may be replaced with an automobile or road vehicle.

The vehicle underbody U may be replaced with a vehicle chassis, a vehicle undertray, a vehicle body, a vehicle floor or a vehicle structure.

The battery frame 20 comprises a tray 22 having a floor 24. The tray 22 is generally rectangular when viewed in plan and is configured to receive and/or support a battery, in use. The battery frame 20 is shown with a battery B positioned within the tray 22 in this embodiment, and located between the floor 24 and the vehicle underbody U. It will be appreciated that the battery frame 20 may comprise one or more batteries that, in use, are at least partially received within the tray 22 or are mounted to a periphery of the battery frame 20. The tray 22 may be replaced with a receptacle or a housing.

The tray 22 describes an internal volume V and is defined by a first widthwise extending beam 26a, a second widthwise extending beam 26b, a first longitudinally extending beam 28a and a second longitudinally extending beam 28b. The beams 26a, 26b, 28a, 28b together describe an outer periphery of the tray 22. The first widthwise extending beam 26a and the second widthwise extending beam 26b extend substantially perpendicular to the longitudinal axis X of the propshaft P. The first longitudinally extending beam 28a and the second longitudinally extending beam 28b each extend substantially parallel to the longitudinal axis X of the propshaft P.

The first and second widthwise extending beams 26a, 26b are spaced from one another along the longitudinal axis X of the propshaft P and extend across a portion of a width of a vehicle, in use. In use, the first widthwise extending beam 26a is located closer to a rear of a vehicle than the second widthwise extending beam 26b.

The first longitudinally extending beam 28a is connected at a first free end of the first and second widthwise extending beams 26a, 26b. The second longitudinally extending beam 28b is connected at a second free end of the first and second widthwise extending beams 26a, 26b. In this embodiment, each of the beams 26a, 26b, 28a, 28b comprises an extruded aluminium profile. However, it will be appreciated that one or more of the beams may be formed of another suitable material. It will also be appreciated that one or more of the beams may be formed by rolling, printing, extrusion or casting.

Each of the beams 26a, 26b, 28a, 28b includes a respective ledge 30a, 30b, 30c, 30d at a free end closest to the propshaft P. Each ledge 30a, 30b, 30c, 30d has a planar surface that faces the vehicle underbody U. The respective ledge 30c. 30d of each of the first and second longitudinally extending beams 28a, 28b includes a battery frame mounting assembly 32. The battery frame mounting 32 assembly includes a plurality of holes 34 extending through each of the ledges 30c, 30d and a plurality of fasteners 36 configured to extend through the holes 34 and into a vehicle body or chassis. The fasteners 36 may comprise screws or bolts and may extend into a vehicle sill.

Three support brackets 40 are located on the first widthwise extending beam 26a to the outside of the internal volume V defined by the tray 22 and on an underside of the ledge 30a, such that the ledge 30a is located between the support brackets 40 and the vehicle underbody U. A central one of the three support brackets 40a has the second end 54 of the battery mount 50 secured thereto.

The floor 24 of the tray 22 is attached to each of the beams 26a, 26b, 28a, 28b at their respective free end furthest from the propshaft P. The floor 24 comprises a plurality of retaining elements 38, in the form of screws in this embodiment, arranged in two lines (only one of which is shown in FIG. 1), wherein each line is located inward of a respective longitudinally extending beam 28a, 28b. Each line extends substantially parallel with the longitudinal axis X of the propshaft P. Each of the retaining elements 38 extends through, and perpendicular to, the floor 24 from an underside towards the vehicle underbody U. The retaining elements 38 are configured to engage with the battery B or a battery housing in order to retain the battery B within the battery frame 20.

The skilled person will appreciate that the battery frame 20 as described, may instead be replaced by a battery casing, a battery housing or a battery module. Furthermore, the battery frame 20 as described may contain, comprise or receive a battery casing, a battery housing or a battery module.

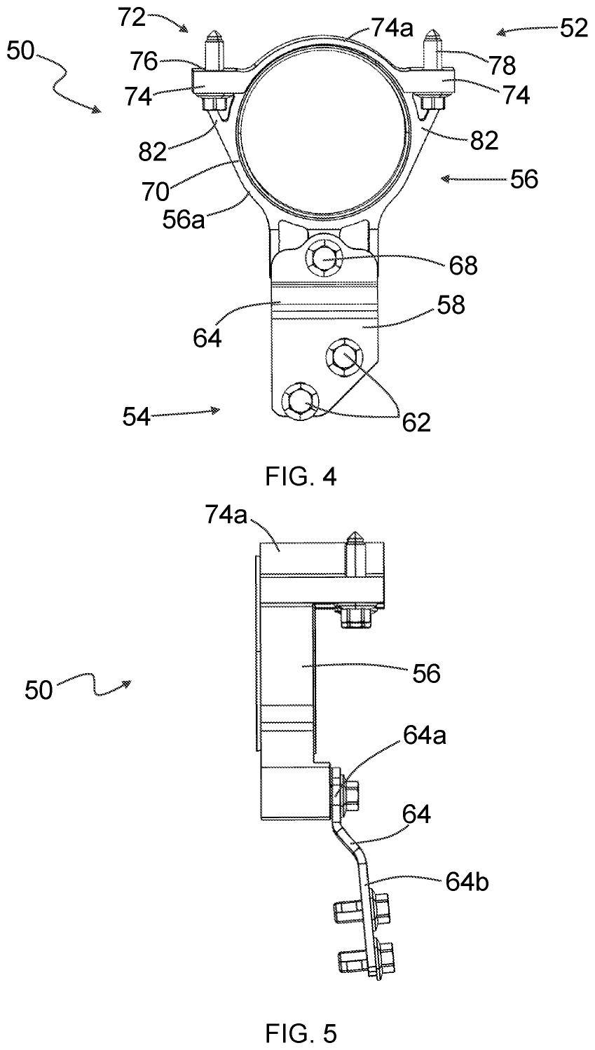

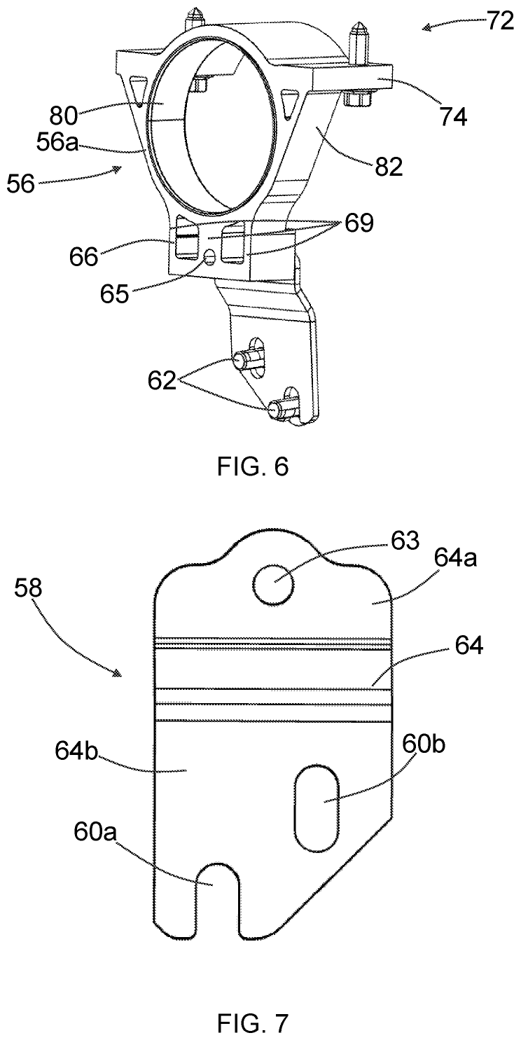

Referring now to FIGS. 4 to 6, there is shown the battery mount 50 in greater detail. It will be appreciated that the propshaft bearing housing 56 may be replaced with a propshaft bracket or a bearing absent housing.

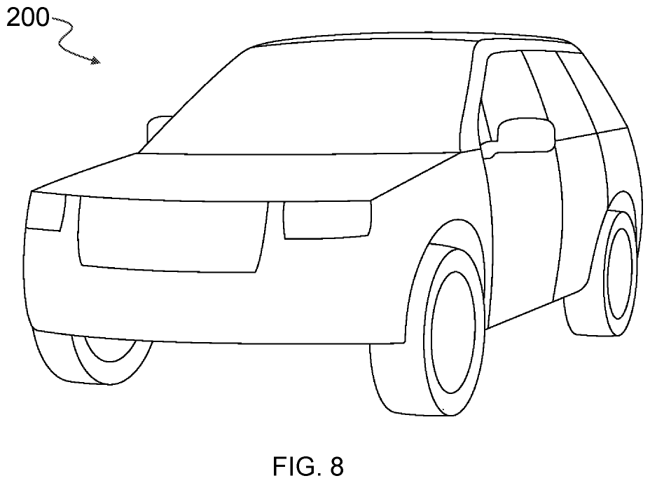

The battery mount 50 includes a mounting bracket 58 (shown in isolation in FIG. 7) for securing the second end 54 to the battery frame 20. The mounting bracket 58 is a stamped aluminium plate in this embodiment and is secured to the battery frame 20 at two points. The mounting bracket 58 includes a first slot 60a and a second slot 60b each in receipt of a respective fastener 62. Each fastener 62 may be a screw or a bolt and extends through a respective slot 60a, 60b and into the support bracket 40a. The first slot 60a is open ended and allows for adjustment of the mounting bracket 58 in a direction transverse to the longitudinal axis X of the propshaft P. i.e. towards and away from the vehicle underbody U. The open ended first slot 60a also facilitates location of the mounting bracket 58 on the battery frame 20 during assembly. The second slot 60b is located closer than the first slot 60a to the propshaft P in this embodiment.

It will be appreciated that the slots be replaced by two apertures or holes. One or more of the slots may be replaced with an aperture or hole.

The mounting bracket 58 is also attached to the propshaft bearing housing 56 at a single point. Specifically, the mounting bracket 58 includes a first mounting aperture 63 on the other side of a kink 64 from the first slot 60a and the second slot 60b. As is shown most clearly in FIGS. 5 and 7, a first planar portion 64a and a second planar portion 64b are provided on either side of the kink 64. The first mounting aperture 63 extends through the first planar portion 64a and the first slot 60a and the second slot 60b each extend through the second planar portion 64b. The planar portions 64a, 64b are offset from one another in the direction of the longitudinal axis X of the propshaft P. The first mounting aperture 63 is aligned and coaxial with a second mounting aperture 65 that extends through a mounting lug 66 extending from the propshaft bearing housing 56. A fastener 68 extends through each of the first mounting aperture 63 and the second mounting aperture 65 to attach the mounting bracket 58 to the propshaft bearing housing 56. The first mounting aperture 63 and the second mounting aperture 65 each extend parallel to the longitudinal axis X of the propshaft P in this embodiment.

By attaching the mounting bracket 58 to the propshaft bearing housing 56 at a single point, the propshaft bearing housing 56 may be displaced relative to the battery frame 20 in the event of an impact in a direction transverse to the longitudinal axis X of the propshaft P. Furthermore, the single attachment point allows for lateral displacement of the propshaft bearing housing 56, in use, which may reduce the transmission of vibration through a vehicle.

The mounting lug 66 is formed integrally with the propshaft bearing housing 56 and extends therefrom via three webs 69. It will be appreciated that the propshaft bearing housing 56 may comprise the mounting lug 66. It will be appreciated that the mounting lug may alternatively be attached or connected to the propshaft bearing housing. The mounting lug 66 has a planar end surface that lies adjacent and spaced from the ledge 30a.

The propshaft bearing housing 56 is formed as a metal extrusion in this embodiment. The propshaft bearing housing 56 has a generally annular portion 56a having an internal annular surface 70 on which is located a two part bearing 80. The propshaft bearing housing 56 includes a fastening assembly 72 at the first end 52 for securing the battery mount 50 to the vehicle underbody U. The fastening assembly 72 includes a pair of flanges 74 extending from opposed sides of an exterior of the propshaft bearing housing 56. Each of the flanges 74 are interconnected by a connecting arc 74a and extend along the longitudinal axis X of the propshaft P beyond the propshaft bearing housing 56. It will be appreciated that the propshaft bearing housing 56 may be replaced by a cast or printed housing.

Each flange 74 has a respective hole 76 extending therethrough. A respective fastener 78 extends through each hole 76 and into a vehicle underbody U. The fastener 78 may be a screw or a bolt. A respective web 82 extends between each flange 74 and the exterior of the propshaft bearing housing 56. The webs 82 provide rigidity to the flanges 74.

Whilst the battery mount 50 is described as having a mounting bracket 58 separate from the propshaft bearing housing 56 for securing the second end 54 to the battery frame 20, it will be appreciated that the mounting bracket and propshaft bearing housing may instead be unitary. It will also be appreciated that the mounting bracket may be replaced with a mounting bracket without a kink, or a flat or planar mounting bracket.

FIG. 8 illustrates a vehicle 200 according to an embodiment of the present invention. The vehicle 200 comprises a vehicle subassembly 10 as illustrated in FIGS. 1 to 3.

It will be appreciated that various changes and modifications can be made to the present invention without departing from the scope of the present application.

1. A vehicle subassembly, comprising:
a vehicle underbody;
a battery;
a propshaft extending along a longitudinal axis and positioned between the vehicle underbody and the battery; and
a battery mount for forming a structural connection between the vehicle underbody and the battery, the battery mount comprising:
a first end fixed to the vehicle underbody;
a second end fixed to the battery; and
a propshaft bearing housing, the propshaft bearing housing configured to rotatably support the propshaft and located between the first end of the battery mount and the second end of the battery mount, wherein the propshaft extends through and is supported by the propshaft bearing housing.

2. The vehicle subassembly according to claim 1, wherein the battery mount comprises a mounting bracket and one or more fasteners securing the second end to the battery.

3. The vehicle subassembly according to claim 2, wherein the mounting bracket is attached to the propshaft bearing housing at a single point.

4. The vehicle subassembly according to claim 3, wherein the propshaft bearing housing comprises a mounting lug and the mounting bracket is attached to the propshaft bearing housing via the mounting lug.

5. The vehicle subassembly according to claim 4, wherein;
the mounting bracket comprises a first mounting aperture;
the mounting lug comprises a second mounting aperture arranged coaxially with the first mounting aperture, and
a fastener is received within each of the first mounting aperture and the second mounting aperture to attach the mounting bracket to the propshaft bearing housing.

6. The vehicle subassembly according to claim 5, wherein the first mounting aperture and the second mounting aperture extend substantially parallel to the longitudinal axis of the propshaft.

7. The vehicle subassembly according to claim 2, wherein the mounting bracket is secured to the battery at two points.

8. The vehicle subassembly according to claim 7, wherein the mounting bracket comprises two slots and a respective fastener extends through each slot to secure the mounting bracket to the battery.

9. The vehicle subassembly according to claim 8, wherein one of the two slots is located closer to the propshaft than the other of the two slots.

10. The vehicle subassembly according to claim 8, wherein one of the two slots is open-ended.

11. The vehicle subassembly according to claim 2, wherein the mounting bracket comprises a kink so that connection between the mounting bracket and the battery is offset in the direction of the longitudinal axis of the propshaft relative to a connection between the mounting bracket and the propshaft bearing housing.

12. The vehicle subassembly according to claim 2, wherein the mounting bracket comprises a stamped plate.

13. The vehicle subassembly according to claim 2, wherein the propshaft bearing housing and mounting bracket are unitary.

14. The vehicle subassembly according to claim 1, wherein the battery mount comprises a fastening assembly at the first end for securing the propshaft bearing housing to the vehicle underbody.

15. The vehicle subassembly according to claim 14, wherein the fastening assembly comprises a pair of flanges extending from an exterior of the propshaft bearing housing.

16. The vehicle subassembly according to claim 15, wherein the fastening assembly comprises a respective hole extending through each flange and a fastener extending through each hole and into the vehicle underbody.

17. The vehicle subassembly according to claim 15, further comprising a web extending between each respective flange and the exterior of the propshaft bearing housing.

18. A vehicle subassembly, comprising:
a vehicle floor;
a battery module;
a propshaft located between the vehicle floor and the battery module; and
a battery mounting assembly comprising:
a first portion connected to the vehicle floor;
a second portion connected to the battery module; and
a propshaft bearing housing, wherein the propshaft extends through the propshaft bearing housing.

19. The vehicle subassembly according to claim 18, wherein the battery mounting assembly comprises:
a mounting bracket and one or more fasteners securing the second portion to the battery module, wherein the mounting bracket is attached to the propshaft bearing housing at a single point and is secured to the battery module at two points;
wherein the mounting bracket comprises two slots and a respective fastener extends through each slot to secure the mounting bracket to the battery module;
wherein the propshaft bearing housing comprises a mounting lug and the mounting bracket is attached to the propshaft bearing housing via the mounting lug;
the battery mounting assembly further comprising a fastening assembly at the first portion for securing the propshaft bearing housing to the vehicle floor.

20. A propshaft mounting assembly, comprising:
a propshaft bearing housing;
a vehicle underbody mounting assembly on a first side of the propshaft bearing housing, the vehicle underbody mounting assembly comprising one or more fasteners for connection to a vehicle underbody; and
a battery mounting assembly on a second side of the propshaft bearing housing, wherein the battery mounting assembly comprises one or more fasteners for connection to a battery frame.
